(19) United States
(12) Patent Application Publication
(10) Pub. No.: US 2019/0038065 A1
(43) Pub. Date: Feb. 7, 2019

(54) PRESS BEVERAGE BREWERS AND RELATED BREWING METHODS

(71) Applicant: Alpha Dominche Holdings, Inc., Dallas, TX (US)

(72) Inventors: Tymer T. Tilton, Brooklyn, NY (US); Olev Tammer, New York City, NY (US)

(21) Appl. No.: 16/054,880

(22) Filed: Aug. 3, 2018

Related U.S. Application Data
(60) Provisional application No. 62/541,405, filed on Aug. 4, 2017.

(51) Int. Cl. A47J 31/20; A47J 31/06

(52) U.S. Cl. CPC A47J 31/20; A47J 31/0605

(57) ABSTRACT

Press beverage brewing assemblies and related brewing methods. In some embodiments, the brewing assembly may comprise a brewing chamber, which may be configured to be received within a receiving chamber, such as a carafe. A valve assembly may be coupled with the brewing chamber and a plunger may be slideably received within the brewing chamber to selectively release a valve, such as a pressure-actuated valve within the brewing chamber, to allow for dispensing of coffee or another brewed beverage from the brewing chamber to the receiving chamber.

### RELATED APPLICATIONS

This application claims the benefit under 35 U.S.C. § 119(e) of U.S. Provisional Patent Application No. 62/541,405 filed Aug. 4, 2017 and titled “PRESS BEVERAGE BREWERS AND RELATED BREWING METHODS,” which application is incorporated herein by reference in its entirety.

### SUMMARY

Beverage brewers and related brewing methods and, more particularly, press beverage brewers and related methods and components and/or assemblies. In preferred embodiments, the brewer may comprise several nested components that fit together and interact to allow for brewing and subsequent, selective release of a brewed beverage within the assembly to separate the brewed beverage from the brewing material/grounds and, optionally, allow the beverage to be poured into another container. Preferably the brewing assembly comprises a brewing chamber comprising a valve and configured to receive a plunger. Upon depressing the plunger, the valve preferably opens by way of the pressure generated by advancing the plunger and then automatically closes after the plunger has been released to separate the beverage from the grounds.

In a more specific example of a brewing assembly for brewing a beverage according to some embodiments, the brewing assembly may comprise a brewing chamber and a valve assembly coupled with the brewing chamber. The valve assembly may comprise a valve configured to selectively open to expel a brewed beverage therethrough and a plunger configured to be slidably received in the brewing chamber. The plunger may be configured to selectively open the valve upon depressing the plunger to expel the brewed beverage therethrough. The brewing assembly may further comprise a receiving chamber, such as a carafe, configured to receive and/or mount the brewing chamber therein. The receiving chamber may be configured to receive the brewed beverage from the brewing chamber upon depressing the plunger to open the valve and expel the brewed beverage therethrough.

In some embodiments, the valve may comprise a pressure-actuated valve configured to automatically open following application of a threshold pressure within the brewing chamber. The valve assembly may be further configured to isolate the brewing chamber from the receiving chamber such that in a natural configuration prior to application of a force on the plunger no liquid is able to pass from the brewing chamber to the delivery chamber.

The brewing assembly may further comprise means for coupling the brewing chamber with the valve assembly and/or means for mounting the brewing chamber within the receiving chamber.

In some embodiments, the valve assembly may be removably coupled with the brewing chamber. The plunger may be configured to wholly expel spent brewing material from the brewing chamber following a brewing process, such as by further depressing the plunger to the bottom of the brewing chamber after the valve assembly has been removed from the brewing chamber.

In some embodiments, the plunger may comprise a flange, such as an annular flange, formed along a perimeter of the plunger. In some such embodiments, the annular flange may form a recession, such as an annular recession, which may face towards the valve assembly when the plunger is positioned within the brewing chamber.

In some embodiments, the plunger may be part of a plunger assembly, which plunger assembly may further comprise a handle and a shaft extending between the handle and the plunger.

In another example of a brewing assembly for brewing a beverage according to other embodiments, the brewing assembly may comprise a brewing chamber configured to brew a beverage therein and a valve coupled with the brewing chamber and configured to selectively open to expel a brewed beverage from the brewing chamber. The assembly may further comprise a plunger configured to be slidably received in the brewing chamber. The plunger may be further configured to selectively open the valve upon depressing the plunger to expel the brewed beverage therethrough. The brewing chamber may be configured to be selectively received within a receiving chamber, such as a carafe configured to receive and/or mount the brewing chamber therein, to receive the brewed beverage from the brewing chamber. Preferably, the brewing chamber is configured to be securely received with the receiving chamber.

Some embodiments may further comprise means for mounting the brewing chamber within the receiving chamber. The means for mounting may be configured to provide a secure coupling between the brewing chamber and the receiving chamber.

In some embodiments, the valve may be part of a valve assembly. In some such embodiments, the valve assembly may further comprise means for coupling the valve assembly with the brewing chamber. In some such embodiments, the means for coupling the valve assembly with the brewing chamber may be configured to allow the valve assembly to be selectively removed from the brewing chamber.

In an example of a method for brewing a beverage according to some implementations, the method may comprise inserting a brewing chamber within a receiving chamber; inserting a brewing material into the brewing chamber; and inserting a liquid onto the brewing material within the brewing chamber to brew a beverage therein. Preferably, the brewing chamber is fluidly sealed with respect to the receiving chamber such that brewed beverage cannot pass from the brewing chamber to the receiving chamber during brewing. Pressure within the brewing chamber may then be increased. In some implementations, the step of increasing pressure within the brewing chamber may comprise depressing a plunger within the brewing chamber to increase the pressure within the brewing chamber. The increase in pressure may result in automatically delivering brewed beverage from the brewing chamber into the receiving chamber.

In some implementations, the step of automatically delivering brewed beverage from the brewing chamber into the receiving chamber may comprise opening a pressure-actuated valve within the brewing chamber, which may be automatically opened by advancing the plunger to increase the pressure within the brewing chamber. In some embodiments and/or implementations, the plunger and the pressure-actuated valve may be configured such that, upon releasing the plunger, the pressure-actuated valve automatically closes to separate the brewing material/grounds from the brewed beverage to prevent over-brewing.

In some embodiments and/or implementations, the brewed beverage may be poured into a separate container with the brewing chamber within the receiving chamber. Thus, the brewing chamber and receiving chamber may be configured to fit together in a precise manner with space provided to allow for dispensing of the beverage with the two chambers coupled together.

The features, structures, steps, or characteristics disclosed herein in connection with one embodiment may be combined in any suitable manner in one or more alternative embodiments.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a cross-sectional view of a brewing chamber according to some embodiments;

FIG. 2 is a cross-sectional view of the brewing chamber of FIG. 1 with a valve assembly coupled thereto;

FIG. 3 is a cross-sectional view of a brewing assembly comprising a brewing chamber with a valve assembly and a receiving chamber;

FIG. 4 depicts the brewing assembly of FIG. 3 with coffee grounds added to a filter positioned on the valve assembly;

FIG. 5 depicts the brewing assembly of FIG. 4 after hot water has been added to the brewing chamber;

FIG. 6 depicts the brewing assembly of FIG. 5 after a plunger has been inserted into the brewing chamber;

FIG. 7 depicts the brewing assembly of FIG. 6 after the plunger has been depressed to open a valve and allow for delivery of brewed coffee into the receiving chamber;

FIG. 8 depicts the brewing assembly of FIG. 7 after complete depression of the plunger and complete delivery of the brewed coffee into the receiving chamber;

FIG. 9 depicts coffee being poured from the receiving chamber with the brewing assembly still positioned within the receiving chamber;

FIG. 10 depicts the valve assembly removed from the brewing chamber to allow for replacement of the coffee grounds;

FIG. 11 is a cross-sectional, partially exploded view of a brewing assembly according to another embodiment;

FIG. 12 is a cross-sectional view of the brewing assembly of FIG. 11 with the brewing chamber of the assembly being positioned within the receiving chamber;

FIG. 13 depicts the brewing assembly of FIG. 12 with coffee grounds being added to the valve assembly;

FIG. 14 depicts the brewing assembly of FIG. 13 after hot water has been added to the brewing chamber with the coffee grounds;

FIG. 15 depicts the brewing assembly of FIG. 14 after a plunger assembly has been inserted into the brewing chamber following brewing of the beverage contained therein;

FIG. 16 depicts the brewing assembly of FIG. 15 as the plunger is being depressed to open a valve and allow for delivery of brewed coffee into the receiving chamber;

FIG. 17 depicts the brewing assembly of FIG. 16 after complete depression of the plunger and complete delivery of the brewed coffee into the receiving chamber;

FIG. 18 depicts the brewing assembly of FIG. 17 with coffee being poured from the receiving chamber with the brewing assembly still positioned within the receiving chamber;

FIG. 19 depicts the brewing chamber after it has been removed from the delivery chamber;

FIG. 20 depicts the valve assembly removed from the brewing chamber to allow for replacement of the coffee grounds;

FIG. 21 depicts the plunger assembly being extended through the bottom of the brewing chamber to expel the spent coffee grounds;

FIG. 22 is a perspective view of a brewing assembly according to yet another embodiment;

FIG. 23 is an exploded, perspective view of the brewing assembly of FIG. 22;

FIG. 24 is a cross-sectional view of the brewing assembly of FIGS. 22 and 23;

FIG. 25 is a perspective view of a plunger assembly for use in connection with a press beverage brewer according to some embodiments; and

FIG. 26 is a cross-sectional, exploded view taken along line 26-26 in FIG. 25 showing the operation of the plunger base of the plunger assembly of FIG. 25 positioned within a brewing chamber.

### DETAILED DESCRIPTION

It will be readily understood that the components of the present disclosure, as generally described and illustrated in the drawings herein, could be arranged and designed in a wide variety of different configurations. Thus, the following more detailed description of the embodiments of the apparatus is not intended to limit the scope of the disclosure, but is merely representative of possible embodiments of the disclosure. In some cases, well-known structures, materials, or operations are not shown or described in detail.

Various embodiments of apparatus and methods are disclosed herein that relate to beverage brewers, such as coffee and/or tea brewers. Some embodiments disclosed herein may allow for full immersion, press-style beverage brewing but may allow for manual delivery of the brewed beverage through a valve using a plunger. This may allow for isolation of the grounds or other brewing material after a desired brewing duration. In some embodiments, the brewing chamber may be received in a receiving chamber, which may be used to dispense the beverage following brewing and dispensing through the valve.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

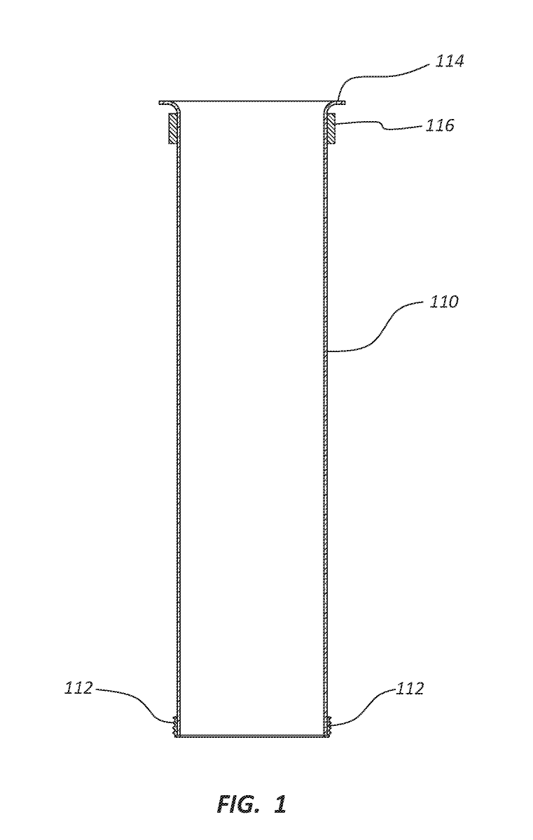

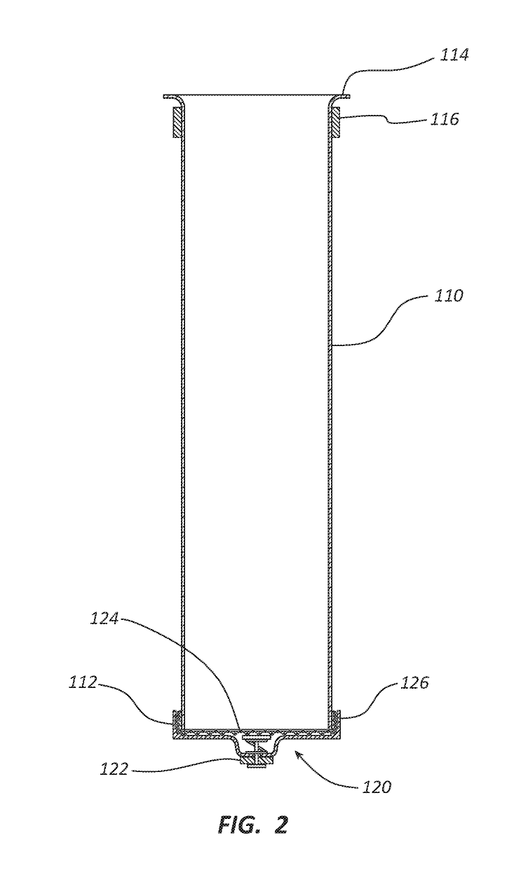

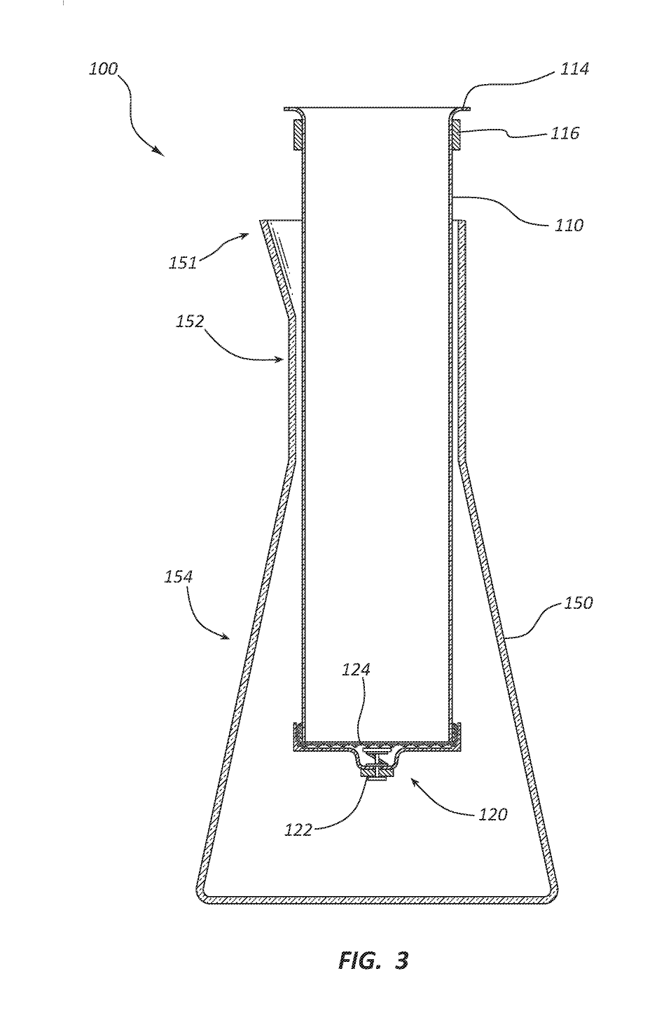

FIG. 1 is a cross-sectional view of a brewing chamber 110 for use in connection with a brewing assembly (see FIG. 3) according to some embodiments. As shown in this figure, brewing chamber 110 may comprise means for coupling 112 the brewing chamber 110 with a valve assembly (see FIG. 2). In the depicted embodiment, the means for coupling comprises external threads 112. However, a variety of alternative means for coupling are contemplated, such as a twist lock or bayonet connector, a snap-fit, and the like. In addition, still other embodiments are contemplated in which the valve and/or valve assembly is an integral part of the brewing chamber.

Brewing chamber 110 may further comprise means for mounting brewing chamber 110 into a receiving chamber, such as a carafe, as discussed below. In the depicted embodiment, the means for mounting brewing chamber 110 into a receiving chamber comprises a lip 114 formed at the upper end of brewing chamber 110 and a spacer 116 positioned at or near the upper end of brewing chamber 110. In preferred embodiments, brewing chamber 110 may comprise a tube having a cylindrical shape. Thus, with respect to such embodiments, spacer 116 may comprise, for example, a ring formed about an upper perimeter of the tube/brewing chamber 110.

FIG. 2 is a cross-sectional view depicting brewing chamber 110 coupled with a valve assembly 120. As shown in this figure, valve assembly 120 may comprise a means for coupling with brewing chamber 110, such as threads 126. In addition, valve assembly 120 comprises a valve 122. Preferably, valve 122 comprises a pressure-actuated valve, which may comprise, for example, a spring, a pressure plate, and a plug positioned adjacent to a valve hole/opening. The spring may be configured to, upon receipt of a predetermined amount of force/pressure, open valve 122 to allow for delivery of a brewed beverage therethrough, as discussed in greater detail below.

In addition, valve assembly 120 may comprise a filter 124. In some embodiments, filter 124 may comprise a metal plate comprising a plurality of holes. In some embodiments, this plate may be configured to serve as the filter alone. Alternatively, filter 124 may comprise a paper filter, or may comprise a plate configured to receive a paper filter.

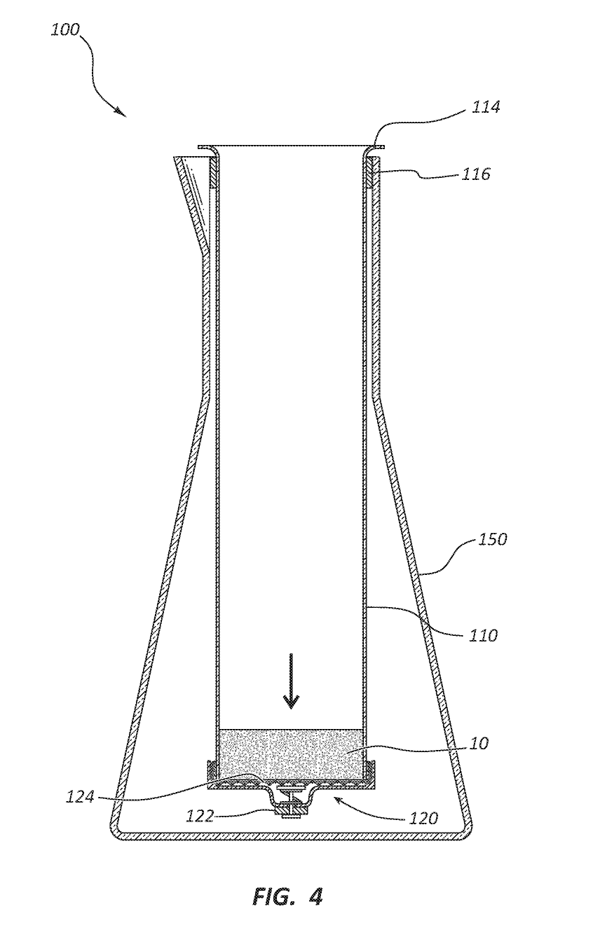

FIG. 3 is a cross-sectional view of a brewing assembly 100 comprising a brewing chamber 110, valve assembly 120, and a receiving chamber 150. In the depicted embodiment, receiving chamber 150 comprises a carafe having a diameter/size big enough to receive brewing chamber 110 therein. In addition, receiving chamber 150 may comprise a spout 151, a widened base 154, and a narrowed portion 152 positioned therebetween. Preferably, receiving chamber 150 and brewing chamber 110 are configured such that brewing chamber 110 may be received within receiving chamber 150 with sufficiently small space therebetween such that brewing chamber 110 may be guided and maintained in a desired, upright position. In addition, receiving chamber 150 and brewing chamber 110 may be configured such that a portion of brewing chamber 110 is engaged with a portion of receiving chamber 150 (such as a top portion, as shown in the accompanying drawings using lip 114 and/or spacer 116) and/or such that space is left in between the outer bottom surface of brewing chamber 110 and the inner bottom surface of receiving chamber 150, as shown in FIG. 4.

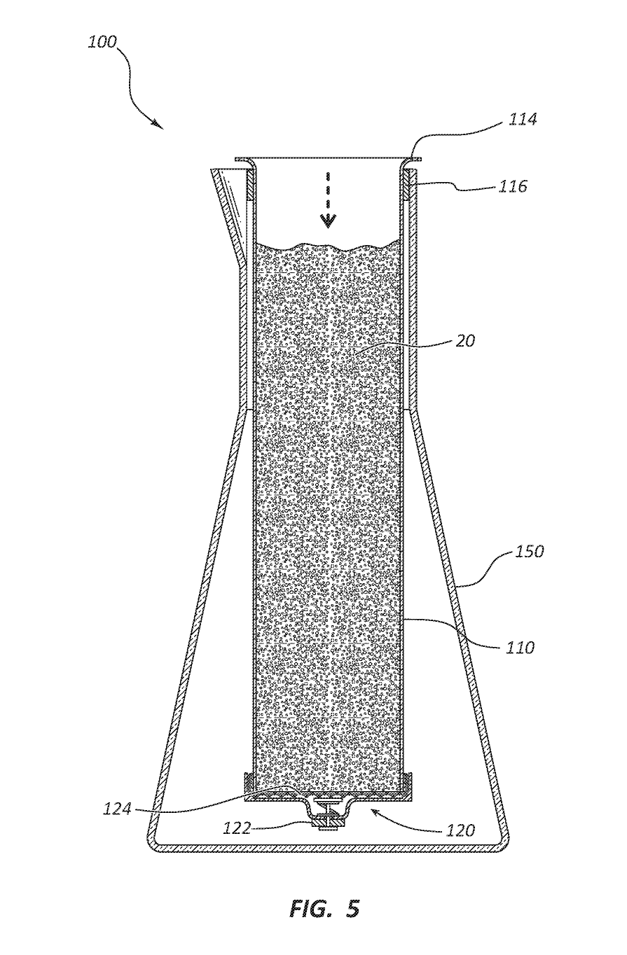

As also shown in FIG. 4, once the brewing chamber 110 has been fully inserted into the receiving chamber 150, a brewing process may begin by inserting a brewing material 10, such as coffee grounds, onto filter 124. A liquid 20, such as heated water, may then be inserted onto the brewing material 10, as shown in FIG. 5. Preferably, valve 122 of valve assembly 120 is of sufficient strength such that brewing chamber 110 may be filled with water or another liquid for brewing without releasing valve 122 and allowing for premature delivery of a brewed beverage into receiving chamber 150.

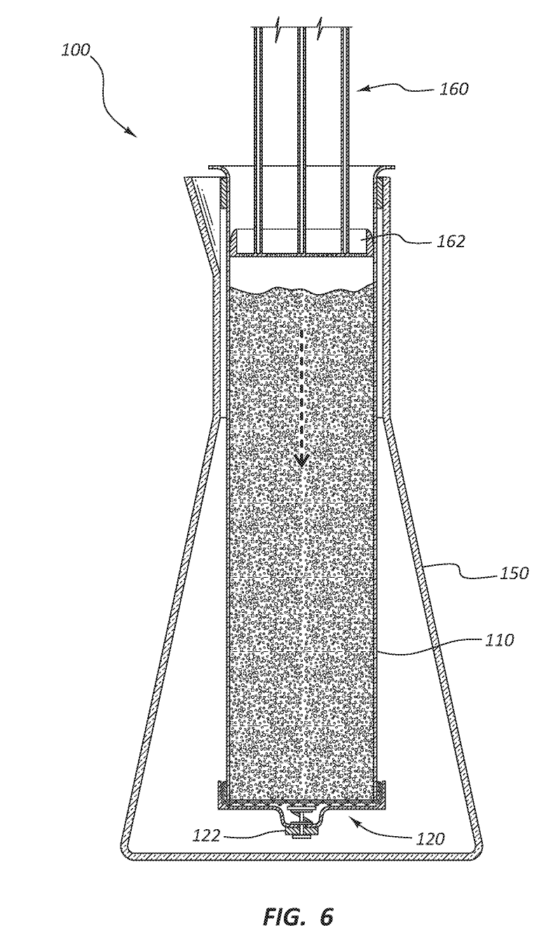

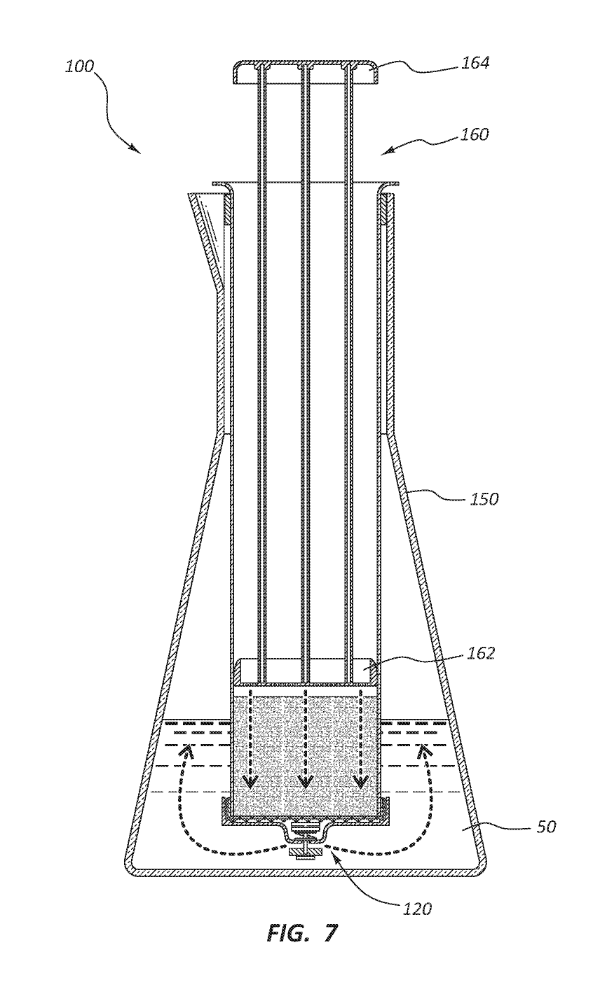

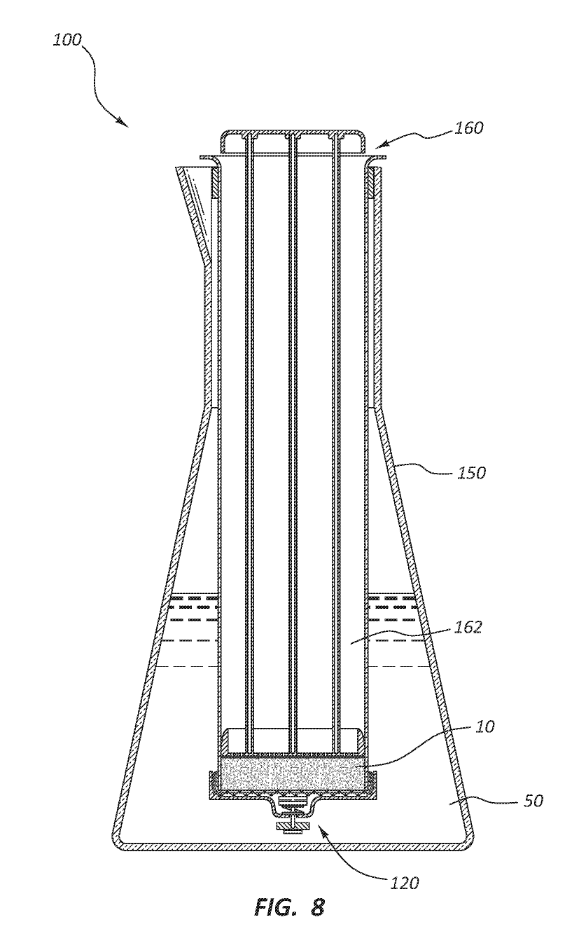

As shown in FIG. 6, brewing assembly 100 may further comprise a plunger 160. Thus, after a desired duration of brewing, plunger 160 may be inserted into brewing chamber 110. Preferably, plunger 160 comprises a plunger base 162 that is configured to be tightly and/or sealingly received within brewing chamber 110. Thus, upon depressing plunger 160 using plunger handle 164 or otherwise causing plunger base 162 to move downward within brewing chamber 110, the pressure within brewing chamber 110 increases and forces valve 122 to open and dispense coffee or another brewed beverage 50 therethrough into receiving chamber 150, as shown in FIG. 7. FIG. 8 depicts brewing assembly 100 following complete dispensing of brewed beverage 50 into receiving chamber 150.

Because receiving chamber 150 is isolated from brewing chamber 110, the spent grounds or other brewing material are separated from the brewed beverage after it is forced through valve 122. This may be preferable for certain applications over, for example, a typical French-press style brewer, which maintains contact with the grounds even after actuation of the plunger and therefore may over steep the beverage if the beverage is not poured from the container in a timely manner. Moreover, in preferred embodiments, by providing a sealed valve during brewing, full steeping of all liquid in the brewing chamber may be maintained without allowing liquid to drip through a filter prior to a desired steeping time.

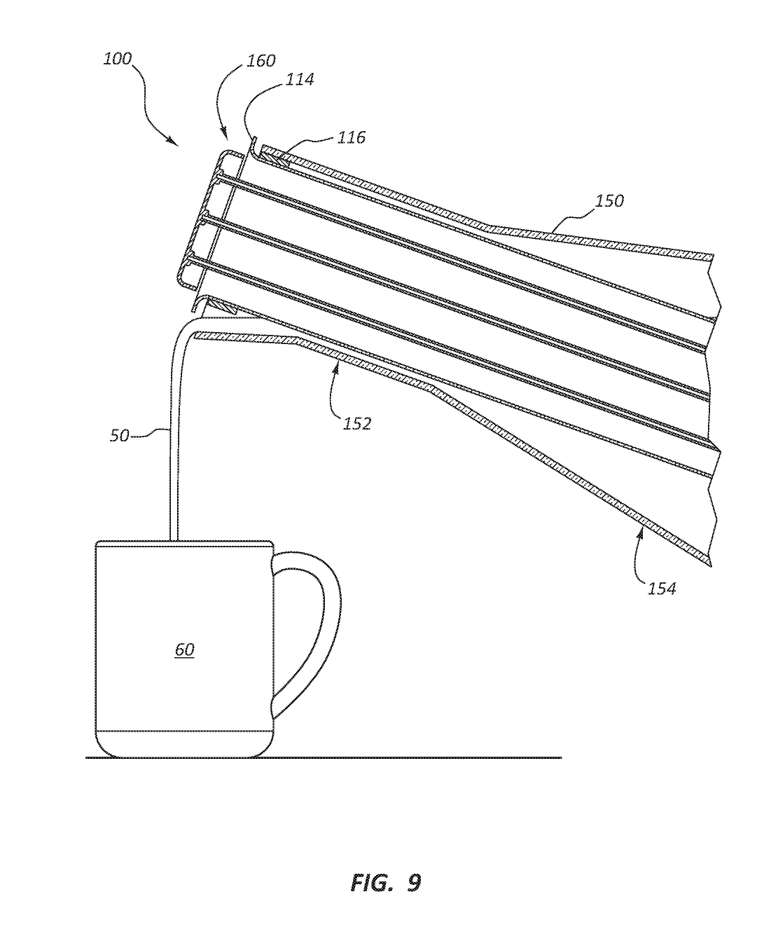

As shown in FIG. 9, after complete dispensing of brewed beverage 50 into receiving chamber 150, brewed beverage 50 may be dispensed directly from receiving chamber 150 into another container 60. Thus, preferably narrowed portion 152 of receiving chamber 150 provides sufficient space to allow for flow of brewed beverage 50 therethrough even with brewing chamber 110 positioned within receiving chamber 150. However, alternative embodiments are contemplated in which brewing chamber 110 may be or, in some embodiments, must be, removed from receiving chamber 150 prior to dispensing or drinking brewed beverage 50.

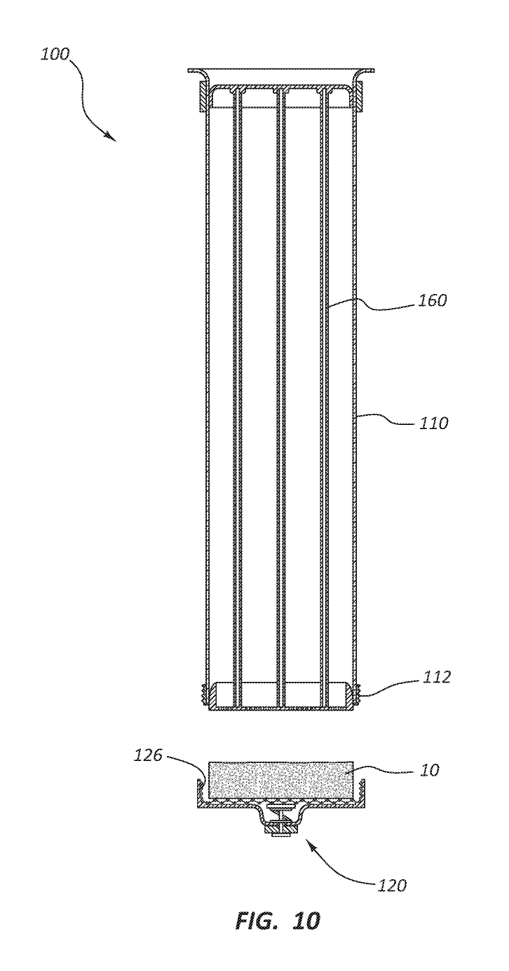

As depicted in FIG. 10, in some embodiments, valve assembly 120 may be removed from brewing chamber 110 following brewing and dispensing of brewed beverage to facilitate removal and/or replacement of brewing material 10.

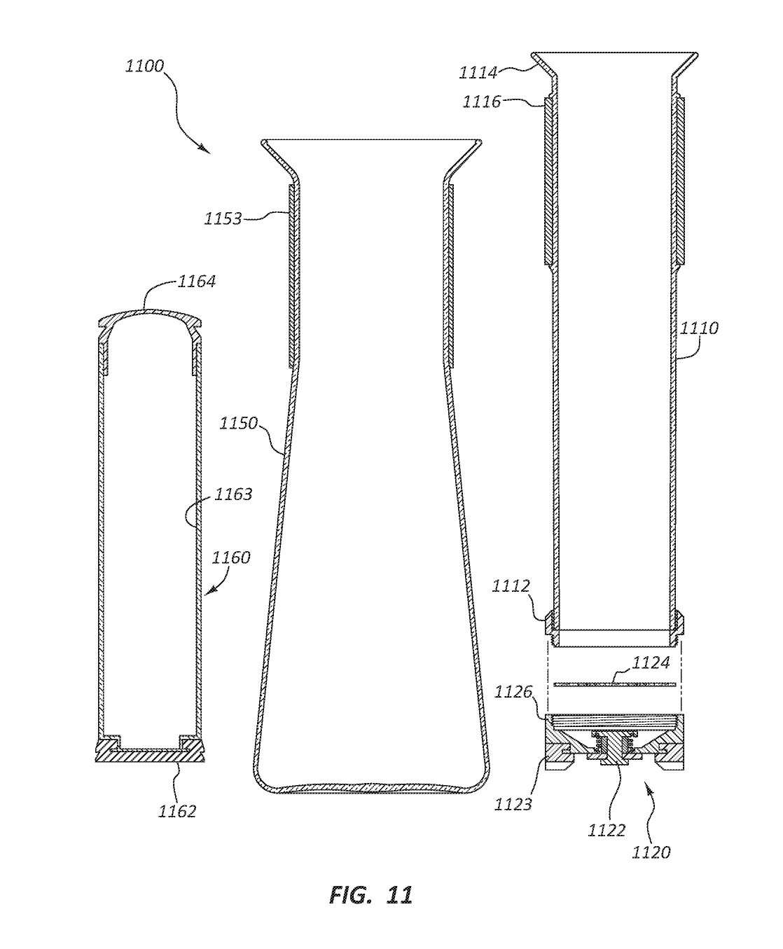

Another brewing assembly 1100 according to another embodiment is shown in FIG. 11. As shown in this figure, brewing assembly 1100 comprises a brewing chamber 1110, a valve assembly 1120, a receiving chamber 1150, and a plunger assembly 1160. The valve assembly 1120 comprises a valve 1122 and is preferably releasably coupleable with the brewing chamber 1110. Assembly 1100 therefore comprises means for coupling the brewing chamber 1110 with the valve assembly 1120. In this embodiment, the means for coupling comprises a twist-lock assembly comprising a male twist-lock fitting 1112 and a female twist-lock fitting 1126, which may be an integral part of valve assembly 1120 or, alternatively, may be a separate and/or separable component.

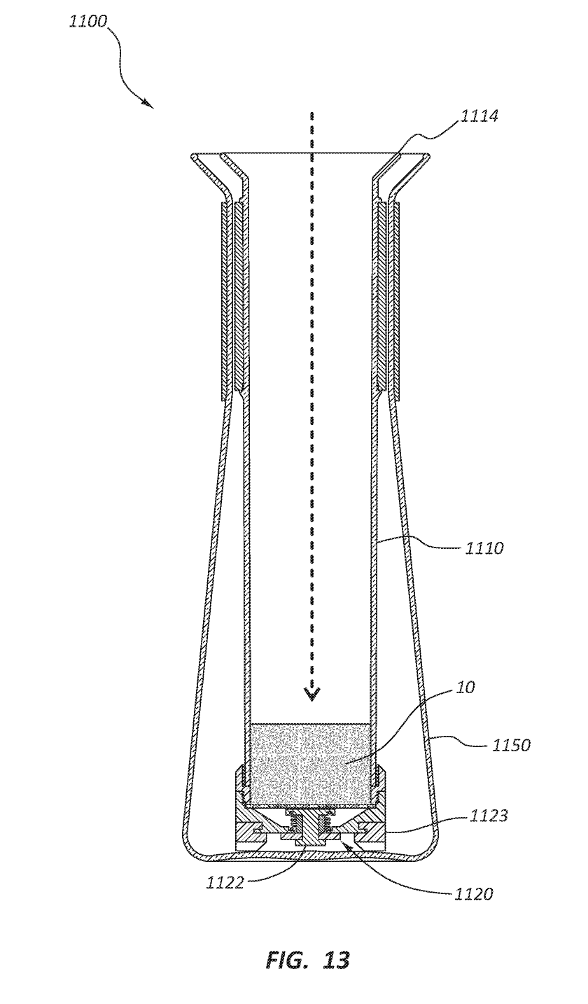

As shown in FIG. 11, valve assembly 1120 further comprises a base 1123, which, unlike assembly 100, may be used to allow for direct contact between valve assembly 1120 and the bottom, interior surface of receiving chamber 1150. Base 1123 may therefore also comprise a relatively soft, malleable material, such as rubber or a suitable plastic. As best shown in FIG. 13, base 1123 preferably is formed so as to create an interior space to allow room for delivery of a brewed beverage through valve 1122 upon opening valve 1122.

Preferably, valve 1122 comprises a pressure-actuated valve, which may comprise, for example, a spring, a pressure plate, and a plug positioned adjacent to a valve hole/opening. The spring may be configured to, upon receipt of a predetermined amount of force/pressure, open valve 1122 to allow for delivery of a brewed beverage therethrough, as previously mentioned.

Brewing chamber 1110 may further comprise means for mounting brewing chamber 1110 into receiving chamber 1150, such as a carafe. In the depicted embodiment, the means for mounting brewing chamber 1110 into a receiving chamber 1150 comprises a lip 1114 formed at the upper end of brewing chamber 1110 and a spacer 1116 positioned at or near the upper end of brewing chamber 1110. In preferred embodiments, brewing chamber 1110 may comprise a tube having a cylindrical shape. Thus, with respect to such embodiments, spacer 1116 may comprise, for example, a ring formed about an upper perimeter of the tube/brewing chamber 1110. Preferably, spacer 1116 comprises a soft, malleable material, such as rubber. Spacer 1116 may also, in some embodiments, be used to create sufficient space between brewing chamber 1110 and delivery chamber 1150 to allow for flow of brewed beverage therebetween.

The same or a similar material may be formed about the exterior of receiving chamber 1150 and may serve as a handle 1153. It may be preferred to form handle 1153 from a material with low heat conductivity to reduce the possibility of burns.

Plunger assembly 1160 comprises a plunger base 1162, a frame 1163, and a handle 1164, which may also serve as a cap to plunger assembly 1160. Handle/cap 1164 may be releasably coupled with frame 1163, such as, for example, by way of a threaded coupling, twist-lock, or the like.

As also shown in FIG. 11, assembly 1100 may further comprise a filter 1124, which may comprise a metal plate comprising a plurality of holes and/or a disposable paper filter.

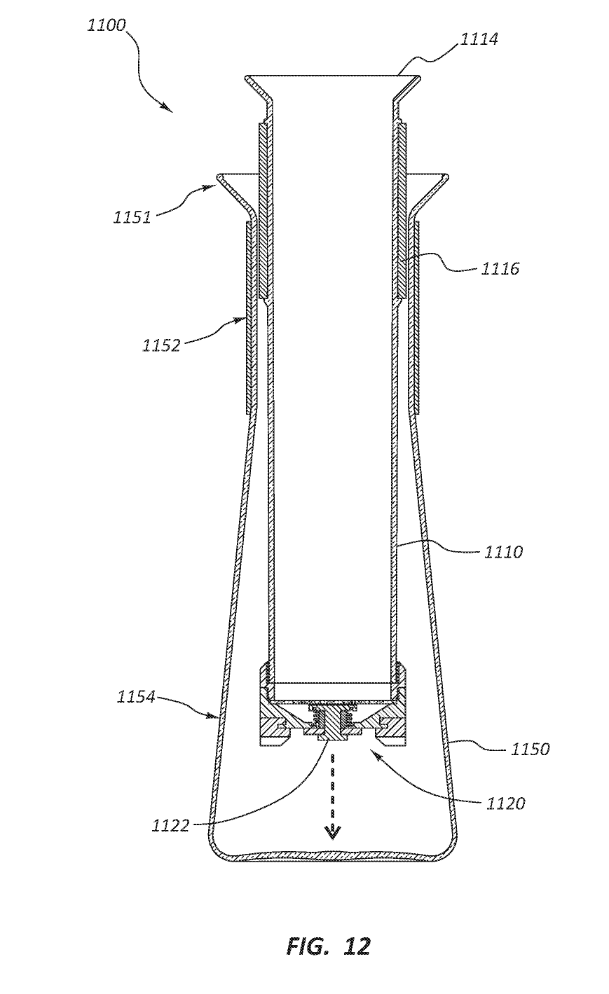

FIG. 12 depicts brewing chamber 1110 coupled with valve assembly 1120 and inserted within receiving chamber/carafe 1150. This configuration may represent a first, or at least an early, step in a brewing process using brewing assembly 1100. As also shown in this figure, receiving chamber 1150 may comprise a spout 1151, a widened base 1154, and a narrowed portion 1152 positioned therebetween. Preferably, receiving chamber 1150 and brewing chamber 1110 are configured such that brewing chamber 1110 may be received within receiving chamber 1150 with sufficiently small space therebetween such that brewing chamber 1110 may be guided and maintained in a desired, upright position. In addition, receiving chamber 1150 and brewing chamber 1110 may be configured such that a portion of brewing chamber 1110 is engaged with a portion of receiving chamber 1150 (such as a top portion, as shown in the accompanying drawings using lip 1114 and/or spacer 1116).

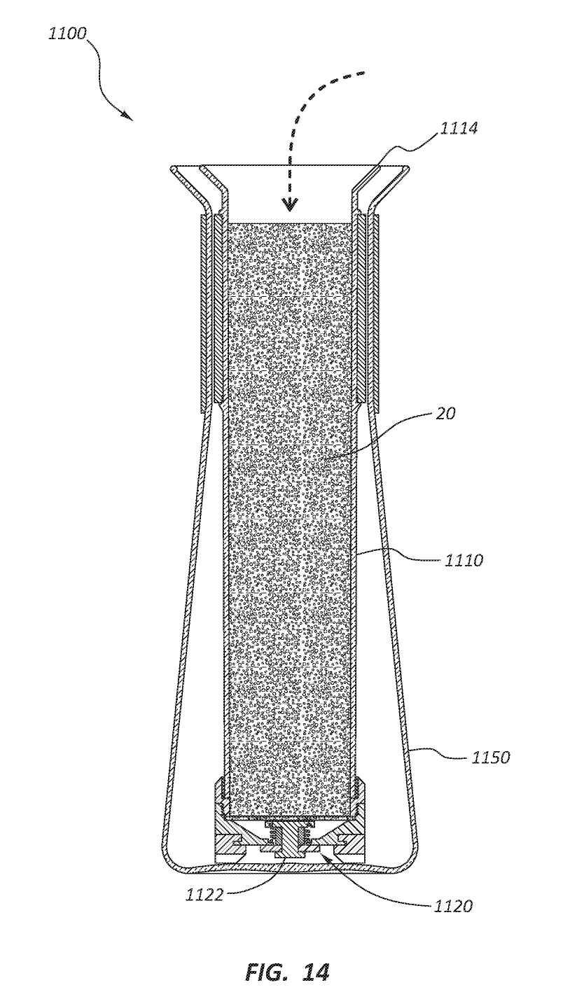

After inserting brewing chamber 1110 into receiving chamber 1150, as shown in FIG. 12, a brewing process may begin by inserting a brewing material 10, such as coffee grounds, onto filter 1124, as shown in FIG. 13. A liquid 20, such as heated water, may then be inserted onto the brewing material 10, as shown in FIG. 14. Preferably, valve 1122 of valve assembly 1120 is of sufficient strength such that brewing chamber 1110 may be filled with water or another liquid for brewing without releasing valve 1122 and allowing for premature delivery of a brewed beverage into receiving chamber 1150.

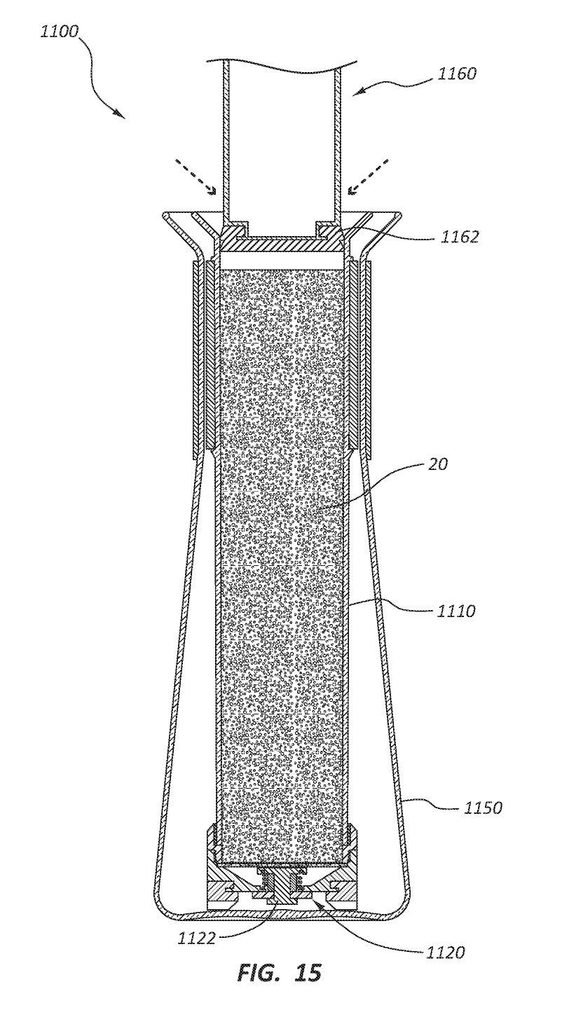

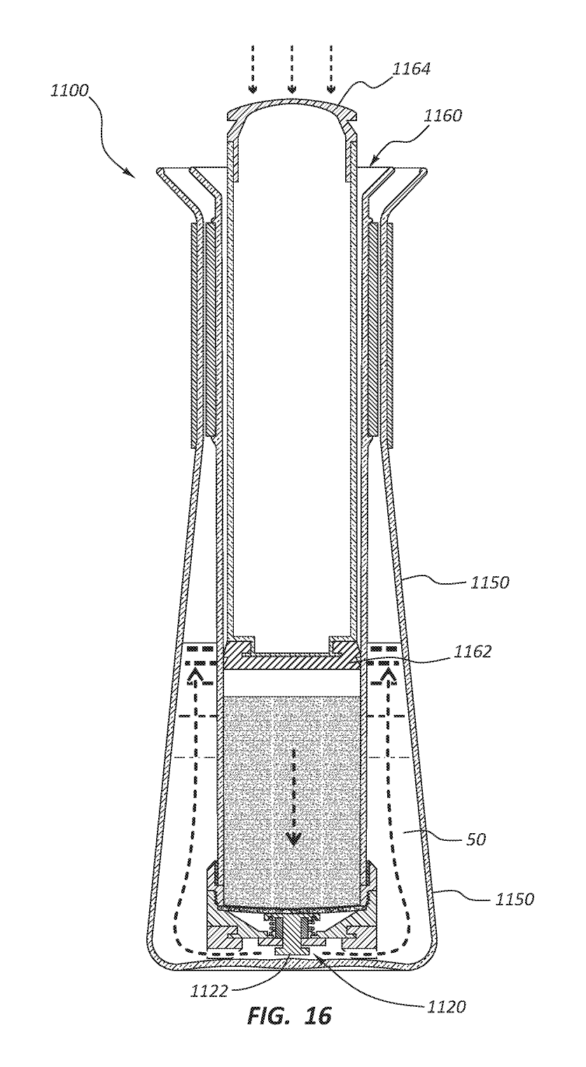

As shown in FIG. 15, after a desired duration of brewing, plunger 1160 may be inserted into brewing chamber 1110. As previously mentioned, upon depressing plunger 1160 using plunger handle 1164 or otherwise causing plunger base 1162 to move downward within brewing chamber 1110, the pressure within brewing chamber 1110 increases and forces valve 1122 to open and dispense coffee or another brewed beverage 50 therethrough into receiving chamber 1150, as shown in FIG. 16.

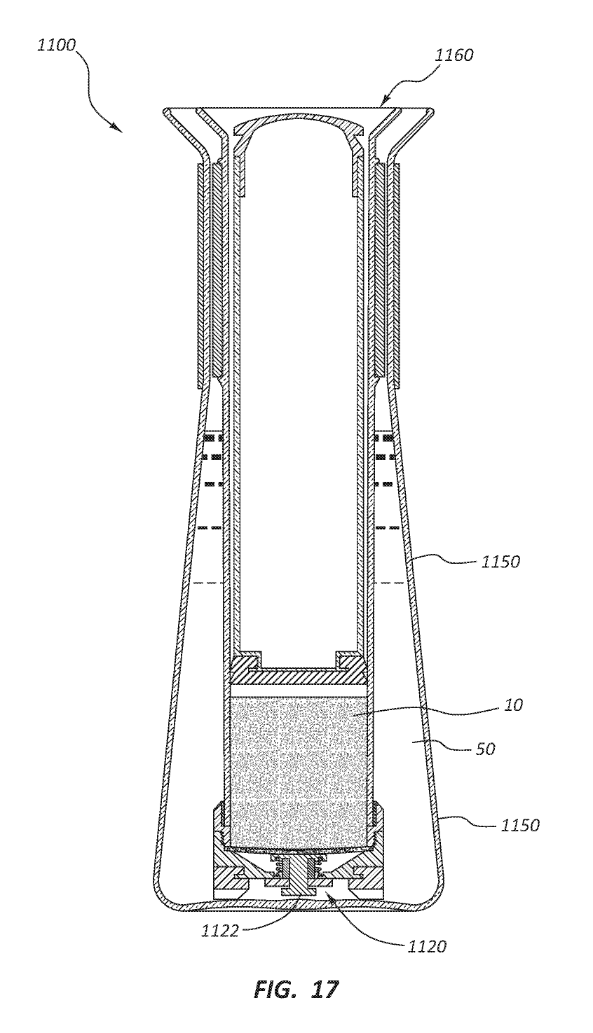

FIG. 17 depicts brewing assembly 1100 following complete dispensing of brewed beverage 50 into receiving chamber 1150. Valve 1122 is preferably configured such that, at this stage, upon releasing plunger assembly 1160, valve 1122 automatically closes in order to separate the brewed beverage 50 from the spent grounds 10.

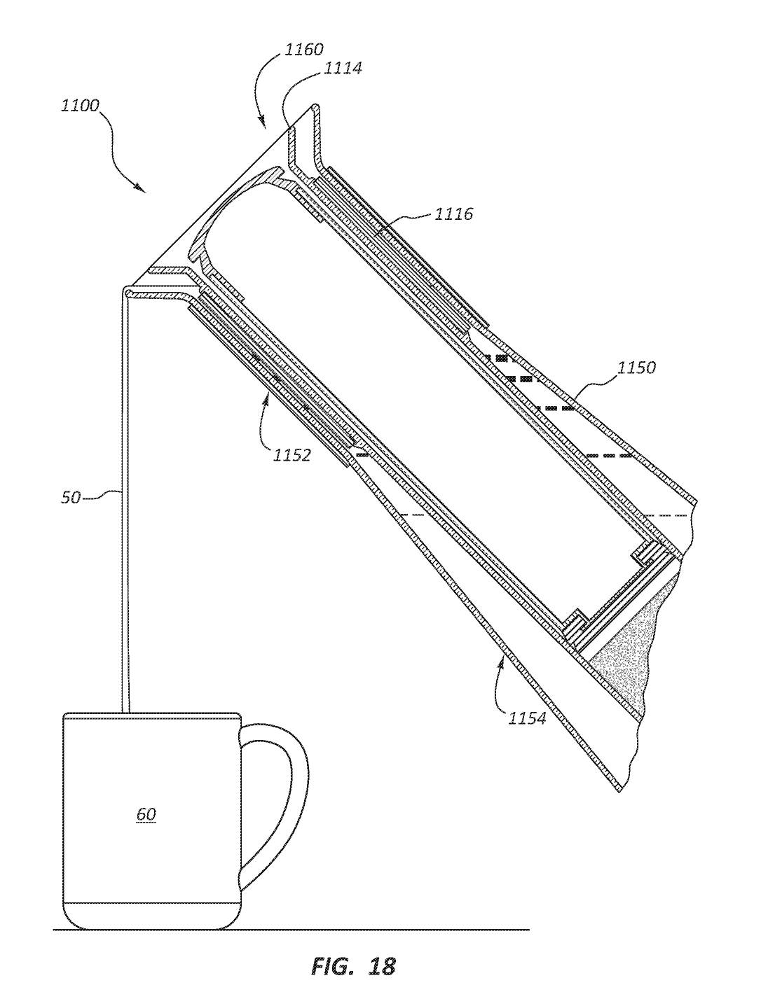

As shown in FIG. 18, after complete dispensing of brewed beverage 50 into receiving chamber 1150, brewed beverage 50 may be dispensed directly from receiving chamber 1150 into another container 60. Thus, preferably narrowed portion 1152 of receiving chamber 1150, in combination with spacer 1116, provides sufficient space to allow for flow of brewed beverage 50 therethrough even with brewing chamber 1110 positioned within receiving chamber 1150.

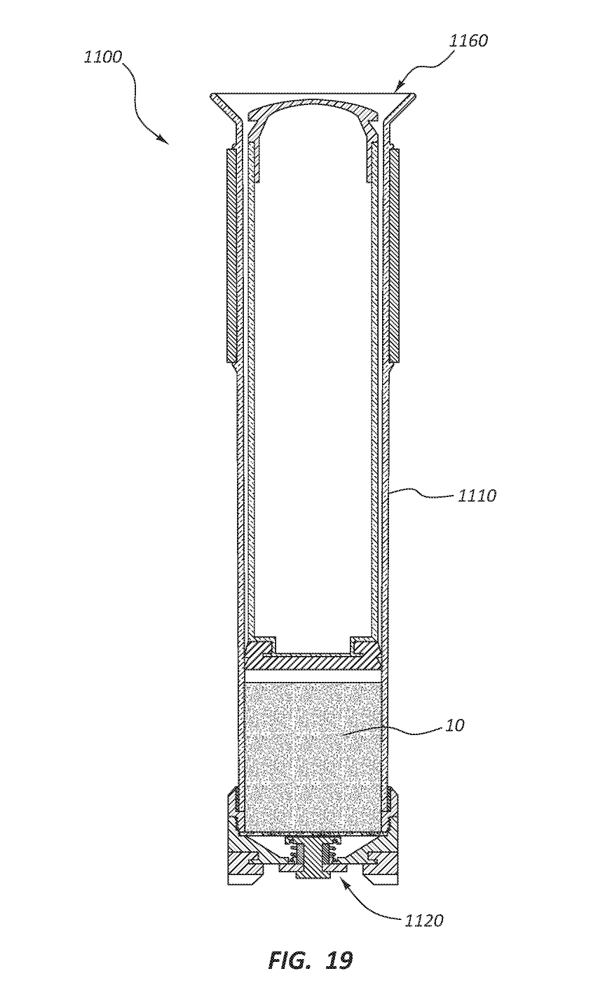

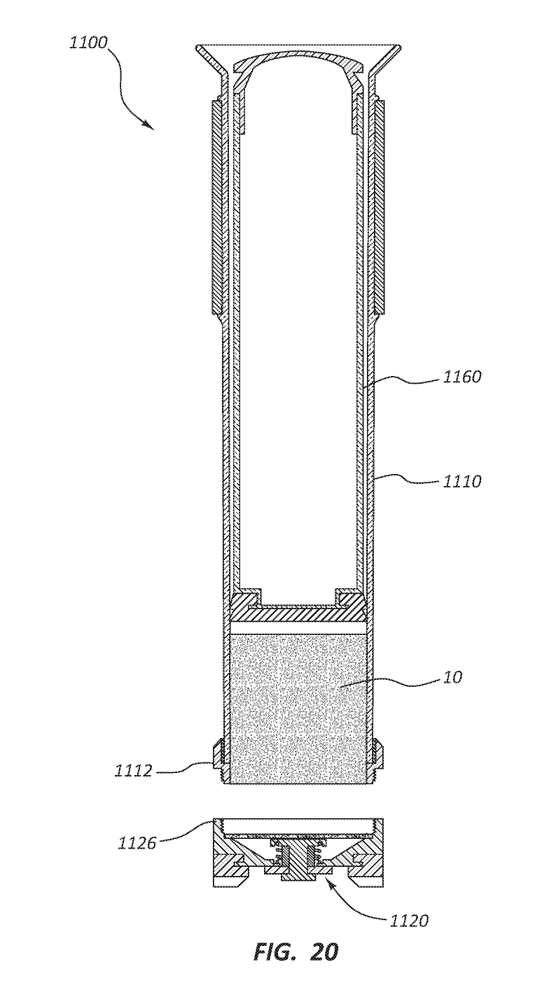

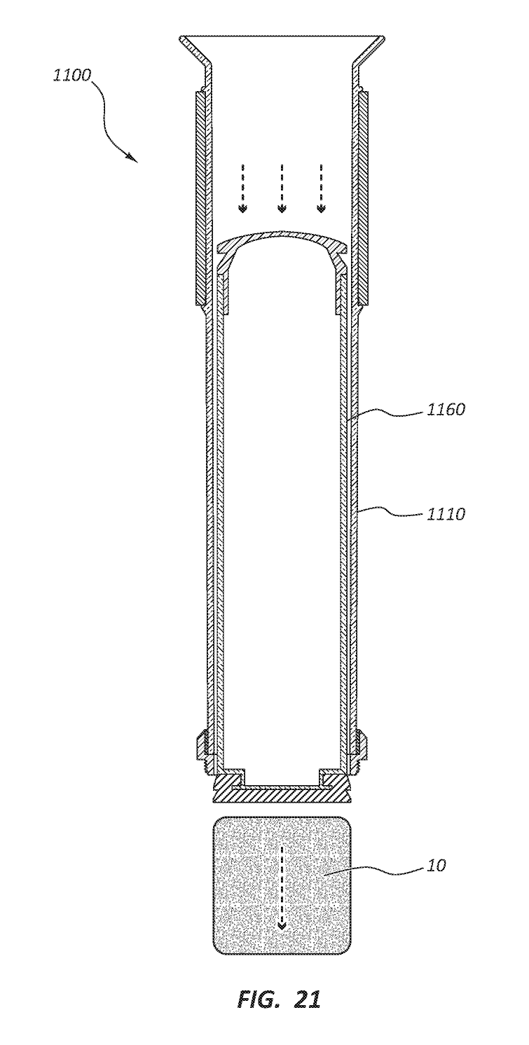

As depicted in FIG. 19, following brewing and dispensing of the brewed beverage 50, brewing chamber 1110 may be removed from delivery chamber 1150. Valve assembly 1120 may then be removed from brewing chamber 1110 to facilitate removal and/or replacement of the spent brewing material 10, and/or cleaning of the assembly 1100, as shown in FIG. 20.

Finally, by continuing to depress plunger assembly 1160 following removal of valve assembly 1120, the spent coffee grounds 10 may be expelled from brewing assembly 1110. This step may also be used to clean the interior of brewing assembly 1110.

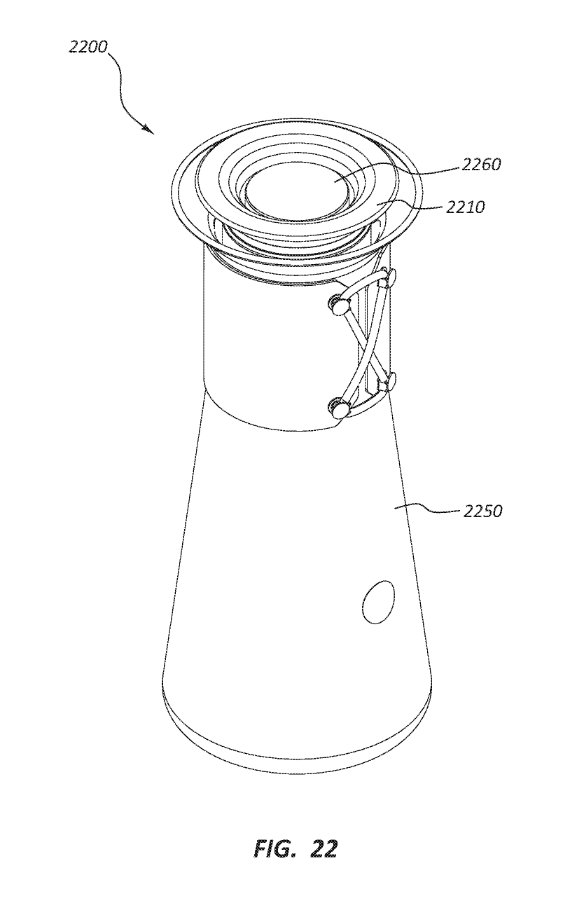

Still another brewing assembly 2200 according to yet another embodiment is shown in FIG. 22. As shown in this figure, brewing assembly 2200 also comprises a brewing chamber 2210 positioned within a carafe/receiving chamber 2250. A plunger assembly 2260 is slidably positioned within brewing chamber 2210. As shown in this figure, each of these three elements nests within the outer element. In addition, both brewing chamber 2210 and receiving chamber 2250 comprise protruding flanges at their respective upper ends that facilitate a desired coupling.

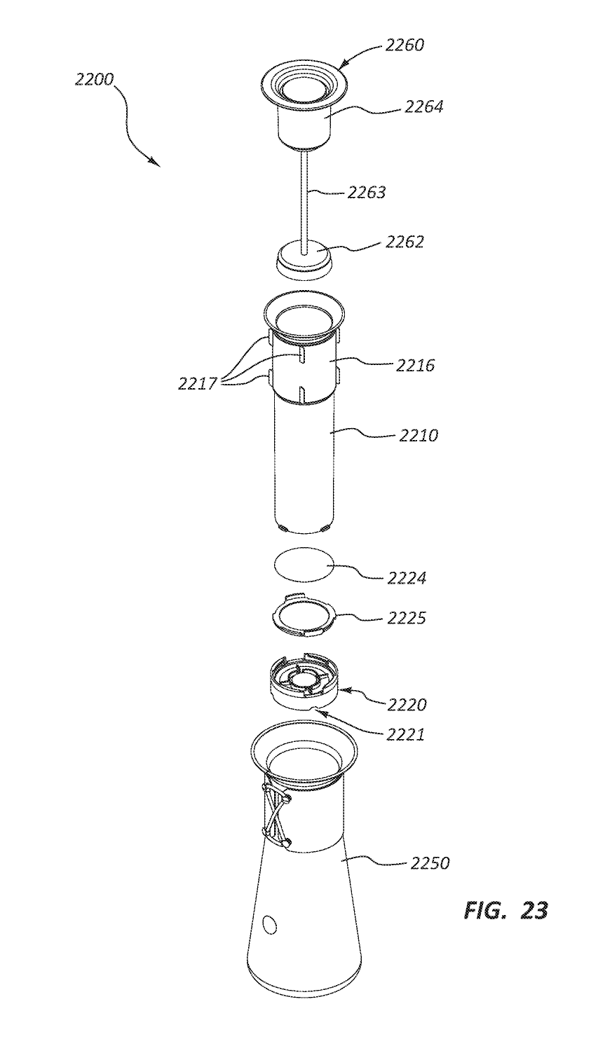

FIG. 23 is an exploded view of brewing assembly 2200. As shown in this view, brewing assembly 2200 further comprises a valve assembly 2220 that is releasably coupleable with the brewing chamber 2210 at the lower end of brewing chamber 2210. Assembly 2200 therefore also comprises means for coupling the brewing chamber 2210 with the valve assembly 2220. In this embodiment, the means for coupling again comprises a twist-lock assembly comprising a male twist-lock fitting and a female twist-lock fitting, which may be an integral part of valve assembly 2220 or, alternatively, may be a separate and/or separable component.

Valve assembly 2220 further comprises a base configured to allow for direct contact between valve assembly 2220 and the bottom, interior surface of receiving chamber 2250. Again, this base preferably comprises a relatively soft, malleable material, such as rubber or a suitable plastic. As also shown in FIG. 23, the base may 3 comprise one or more (a plurality in the depicted embodiment) of slots or openings formed in the side to facilitate delivery of a brewed beverage through valve assembly 2220 and into receiving chamber 2250 upon opening valve 2222.

Preferably, valve 2222 comprises a pressure-actuated valve, which may comprise, for example, a spring, a pressure plate, and a plug positioned adjacent to a valve hole/opening. The spring may be configured to, upon receipt of a predetermined amount of force/pressure, open valve 2222 to allow for delivery of a brewed beverage therethrough, as previously mentioned.

A filter stand 2225 may be positioned on top of valve assembly 2220 and may be configured to receive and/or seat a filter, 2224, which may comprise a permanent filter, such as a metallic filter, or a disposable/paper filter.

Brewing chamber 2210 may further comprise means for mounting brewing chamber 2210 into receiving chamber 2250. In the depicted embodiment, the means for mounting brewing chamber 2210 into a receiving chamber 2250 comprises a lip 2214 formed at the upper end of brewing chamber 2210 and a spacer 2216 positioned at or near the upper end of brewing chamber 220. Preferably, spacer 2216 comprises a soft, malleable material, such as rubber. Spacer 2216 may also, in some embodiments, be used to create sufficient space between brewing chamber 2210 and delivery chamber 2250 to allow for flow of brewed beverage therebetween. In addition, in the embodiment depicted in FIG. 23, spacer 2216 comprises a plurality of protruding tabs 2217 that may also be useful in centering and/or positioning brewing chamber 2210 in a nested configuration within receiving chamber 2210.

The same or a similar material may be formed about the exterior of receiving chamber 2250 and may serve as a handle 2253. It may be preferred to form handle 2253 from a material with low heat conductivity to reduce the possibility of burns.

Plunger assembly 2260 comprises a plunger base 2262, a shaft 2263, and a handle 2264, which may also serve as a cap to plunger assembly 2260. As described in greater detail in later figures, plunger base 2262 comprises a flexible flange 2265 extending about its perimeter that forms an annular cup or recession 2266 about the lower rim of base 2262. This flange enhances the functionality of the plunger as described below.

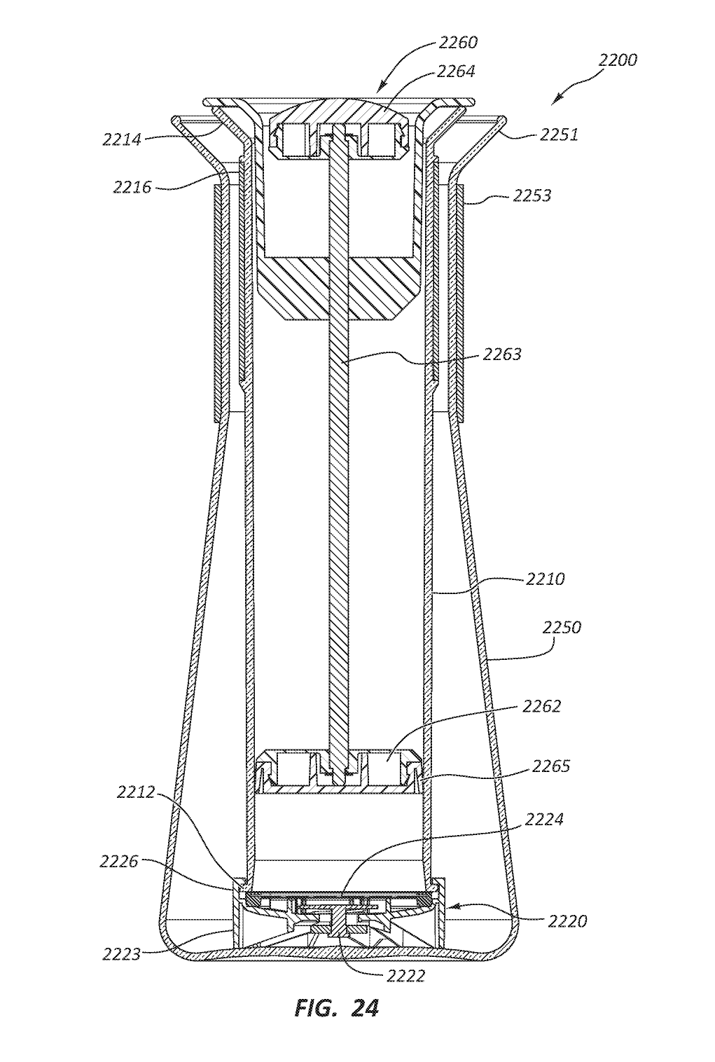

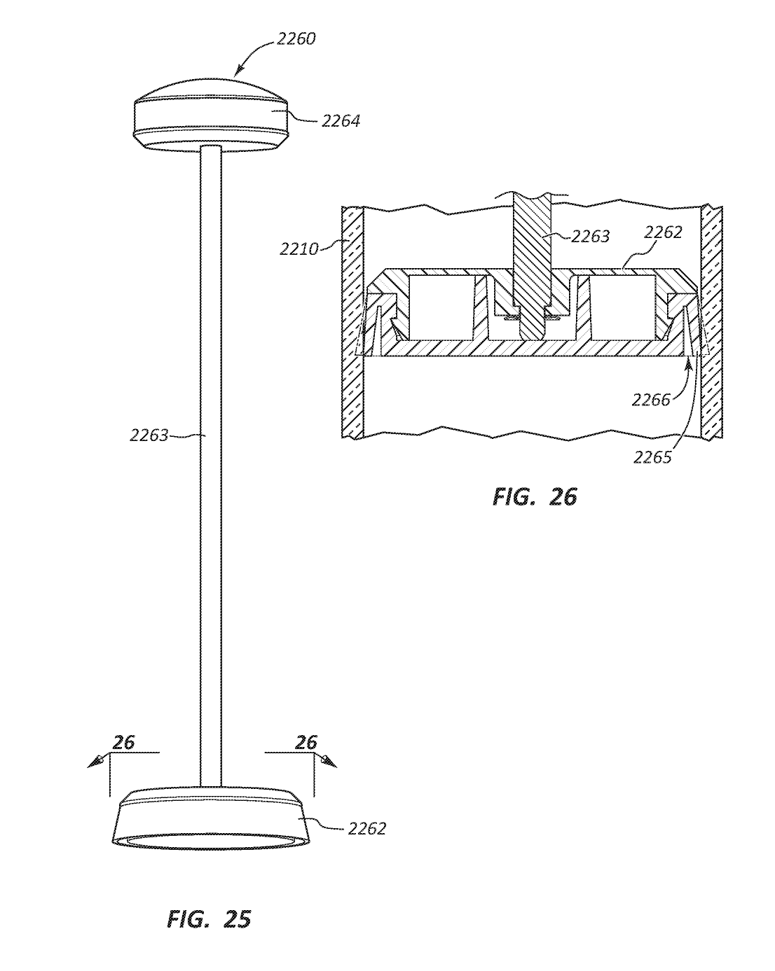

FIG. 24 is a cross-sectional view of brewing chamber 2210 coupled with valve assembly 2220 and inserted within receiving chamber/carafe 2250. As also shown in this figure, receiving chamber 2250 may comprise a spout 2251 and a widened base, and a narrowed portion positioned therebetween. Preferably, receiving chamber 2250 and brewing chamber 2210 are configured such that brewing chamber 2210 may be received within receiving chamber 2250 with sufficiently small space therebetween such that brewing chamber 2210 may be guided and maintained in a desired, upright position. In addition, receiving chamber 2250 and brewing chamber 2210 are preferably configured such that a portion of brewing chamber 2210 nests with or is otherwise engaged with a portion of receiving chamber 2250 (such as a top portion, as shown in the accompanying drawings using lip 2214 and/or spacer 2216).

As previously mentioned, a brewing processing using brewing assembly 2200 may comprise inserting brewing chamber 2210 into receiving chamber 2250, inserting a brewing material, such as coffee grounds, onto filter 2224, and inserting a liquid, such as heated water, onto the brewing material to begin brewing. Preferably, valve 2222 of valve assembly 2220 is of sufficient strength such that brewing chamber 2210 may be filled with water or another liquid for brewing without releasing valve 2222 and allowing for premature delivery of a brewed beverage into receiving chamber 2250.

After a desired duration of brewing, plunger 2260 may be inserted into brewing chamber 2210, resulting in an increase in pressure within brewing chamber 2210, thereby automatically opening valve 2222 to dispense coffee or another brewed beverage therethrough and into receiving chamber 2250. Preferably, plunger 2260 comprises a flexible portion so that it can vary its outside diameter by flexure to seal against the inner surface of brewing chamber 2210. This may be particularly preferred in embodiments in which the inner diameter of brewing chamber 2210 is tapered or otherwise varies. This configuration may also be preferred to lower the force required to depress plunger 2260 since providing a flexible plunger along its outer diameter that varies in diameter allows for avoiding a solid interference fit between the plunger 2260 and the brewing chamber 2210.

Thus, preferably the natural or free state of the outer diameter of plunger base 2262 is larger than at least the portion of brewing chamber 2210 defining the opening, as indicated by the phantom lines in FIG. 26. In some embodiments, the entire inner diameter of brewing chamber 2210 at least along the length of engagement is smaller than the natural or free-state outer diameter of plunger base 2262. However, preferably plunger base 2262 is further configured to flex to decrease the outer diameter in a compressed or flexed state to provide a tight fit within brewing chamber 2210.

In the depicted embodiment, these benefits are provided by forming an annular gap or recession 2266 about the lower perimeter of plunger base 2262, as best shown in FIG. 26. This gap or recession 2266 may be provided by forming an annular flange 2265 that forms this gap in between flange 2265 and the portion of plunger base 2262 defining a rim inside of annular flange 2265.

This gap/flange 2265 may be self-energizing due to both the downward drag against the inner surface of brewing chamber 2210 and the fluid pressure generated below plunger base 2262 by a user depressing plunger 2260. More particularly, the gap provided by flexible, annular flange 2265 counter balances the increased fluid pressure generated by the user during depression of plunger 2260 and may reduce and/or balance the forces required to achieve a given flow rate of brewed beverage through valve 2222.

The shape of gap/flange 2265 is configured to operate similar to the manner of a one-way clutch that may be tuned by adjusting the angle between the outer surface of flange 2265 and the central axis of plunger base 2262 and/or the adjacent surface defining the annular gap. Thus, in preferred embodiments, this angle in the free or unflexed state of plunger base 2262 may be between about 7.5 and about 17.5 degrees. In some such embodiments, this angle may be about 12.5 degrees.

In preferred embodiments, annular flange 2265 may comprise an elastomer, preferably of a relatively stiff material having lesser friction, such as a Shore 95A material or another suitable silicone rubber. Use of higher friction materials may generate more sealing force but may be prone to locking up during use. Use of a platinum-cured silicone rubber may be particularly preferred to avoid imparting unwanted flavors to the beverage.

Annular flange 2265 may also be configured to release the “clutch” forces by pulling the plunger 2260 upwards. Preferably, annular flange 2265 is configured to collapse radially inward due to suction during this withdrawal action, thereby allowing air to leak past to facilitate extraction of the plunger assembly 2260.

As previously mentioned, following brewing and dispensing of the brewed beverage, brewing chamber 2210 may be removed from delivery chamber 2250. Valve assembly 2220 may also be removed from brewing chamber 2210 to facilitate removal and/or replacement of the spent brewing material and/or cleaning. In the depicted embodiment, by continuing to depress plunger assembly 2260 following removal of valve assembly 2220, the spent coffee grounds may be expelled from brewing assembly 2210 and may wipe the interior of brewing assembly 2210 clean, which may minimize the need for more thorough cleaning.

Valve 2222 is also preferably configured such that, upon releasing plunger assembly 2260, valve 2222 automatically closes in order to separate the brewed beverage from the spent brewing material.

It will be understood by those having skill in the art that changes may be made to the details of the above-described embodiments without departing from the underlying principles presented herein. Any suitable combination of various embodiments, or the features thereof, is contemplated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, inventive aspects lie in a combination of fewer than all features of any single foregoing disclosed embodiment. It will be apparent to those having skill in the art that changes may be made to the details of the above-described embodiments without departing from the underlying principles set forth herein.

1. A brewing assembly for brewing a beverage, comprising:
a brewing chamber;
a valve assembly coupled with the brewing chamber, wherein the valve assembly comprises a valve configured to selectively open to expel a brewed beverage therethrough;
a plunger configured to be slidably received in the brewing chamber, wherein the plunger is configured to selectively open the valve upon depressing the plunger to expel the brewed beverage therethrough; and
a receiving chamber configured to receive the brewing chamber therein, wherein the receiving chamber is configured to receive the brewed beverage from the brewing chamber upon depressing the plunger to open the valve and expel the brewed beverage therethrough.

2. The brewing assembly of claim 1, wherein the valve comprises a pressure-actuated valve configured to automatically open following application of a threshold pressure within the brewing chamber.

3. The brewing assembly of claim 1, wherein the valve assembly is configured to isolate the brewing chamber from the receiving chamber such that in a natural configuration prior to application of a force on the plunger no liquid is able to pass from the brewing chamber to the delivery chamber.

4. The brewing assembly of claim 1, further comprising means for coupling the brewing chamber with the valve assembly.

5. The brewing assembly of claim 1, wherein the receiving chamber comprises a carafe.

6. The brewing assembly of claim 1, wherein at least one of the receiving chamber and the brewing chamber comprises means for mounting the brewing chamber within the receiving chamber.

7. The brewing assembly of claim 1, wherein the valve assembly is removably coupled with the brewing chamber.

8. The brewing assembly of claim 7, wherein the plunger is configured to wholly expel spent brewing material from the brewing chamber following a brewing process.

9. The brewing assembly of claim 1, wherein the plunger comprises an annular flange formed along a perimeter of the plunger, and wherein the annular flange forms a recession facing towards the valve assembly when the plunger is positioned within the brewing chamber.

10. The brewing assembly of claim 9, wherein the plunger is part of a plunger assembly, and wherein the plunger assembly further comprises a handle and a shaft extending between the handle and the plunger.

11. A brewing assembly for brewing a beverage, comprising:
a brewing chamber configured to brew a beverage therein;
a valve coupled with the brewing chamber and configured to selectively open to expel a brewed beverage from the brewing chamber; and
a plunger configured to be slidably received in the brewing chamber, wherein the plunger is configured to selectively open the valve upon depressing the plunger to expel the brewed beverage therethrough.

12. The brewing assembly of claim 11, wherein the brewing chamber is configured to be selectively received within a receiving chamber to receive the brewed beverage from the brewing chamber, and wherein the brewing chamber is configured to be securely received with the receiving chamber.

13. The brewing assembly of claim 12, further comprising means for mounting the brewing chamber within the receiving chamber, wherein the means for mounting is configured to provide a secure coupling between the brewing chamber and the receiving chamber.

14. The brewing assembly of claim 11, wherein the valve is part of a valve assembly, and wherein the valve assembly further comprises means for coupling the valve assembly with the brewing chamber.

15. The brewing assembly of claim 14, wherein the means for coupling the valve assembly with the brewing chamber is configured to allow the valve assembly to be selectively removed from the brewing chamber.

16. A method for brewing a beverage, the method comprising the steps of:
inserting a brewing chamber within a receiving chamber;
inserting a brewing material into the brewing chamber;
inserting a liquid onto the brewing material within the brewing chamber to brew a beverage therein, wherein the brewing chamber is fluidly sealed with respect to the receiving chamber such that brewed beverage cannot pass from the brewing chamber to the receiving chamber during brewing;
increasing pressure within the brewing chamber; and
automatically delivering brewed beverage from the brewing chamber into the receiving chamber upon increasing pressure within the brewing chamber.

17. The method of claim 16, wherein the step of increasing pressure within the brewing chamber comprises depressing a plunger within the brewing chamber to increase the pressure within the brewing chamber.

18. The method of claim 17, wherein the step of automatically delivering brewed beverage from the brewing chamber into the receiving chamber upon increasing pressure within the brewing chamber comprises opening a pressure-actuated valve within the brewing chamber, and wherein the plunger and the pressure-actuated valve are configured such that, upon releasing the plunger, the pressure-actuated valve automatically closes.

19. The method of claim 16, wherein the step of automatically delivering brewed beverage from the brewing chamber into the receiving chamber upon increasing pressure within the brewing chamber comprises opening a pressure-actuated valve within the brewing chamber.

20. The method of claim 16, further comprising pouring the brewed beverage into a separate container with the brewing chamber within the receiving chamber.
